(19) United States
(12) Patent Application Publication
(10) Pub. No.: US 2015/0050467 A1
(43) Pub. Date: Feb. 19, 2015

(54) INK FOR AQUEOUS INKJET RECORDING, INKJET RECORDING METHOD, AND INKJET PRINTED MATTER

(71) Applicants: Tomohiro Nakagawa, Kanagawa (JP); Naohiro Toda, Kanagawa (JP); Hidefumi Nagashima, Kanagawa (JP); Juichi Furukawa, Kanagawa (JP); Ichiroh Fujii, Kanagawa (JP)

(72) Inventors: Tomohiro Nakagawa, Kanagawa (JP); Naohiro Toda, Kanagawa (JP); Hidefumi Nagashima, Kanagawa (JP); Juichi Furukawa, Kanagawa (JP); Ichiroh Fujii, Kanagawa (JP)

(73) Assignee: RICOH COMPANY, LTD., Tokyo (JP)

(21) Appl. No.: 14/447,760

(22) Filed: Jul. 31, 2014

(30) Foreign Application Priority Data
Aug. 19, 2013 (JP) 2013-169968

(51) Int. Cl. C09D 11/322; C09D 11/102; B41J 11/00

(52) U.S. Cl. CPC C09D 11/322; B41J 11/002; C09D 11/102
USPC 428/195.1; 347/100; 524/591

(57) ABSTRACT

Ink for aqueous inkjet recording contains water, a hydrosoluble organic solvent; a pigment; and an acrylic-modified polycarbonate-based urethane resin that contains at least one of an acrylic monomer, a methacrylic monomer, and an alkylester thereof as components.

### CROSS-REFERENCE TO RELATED APPLICATION

This patent application is based on and claims priority pursuant to 35 U.S.C. §119 to Japanese Patent Application No. 2013-169968 on Aug. 19, 2013 in the Japan Patent Office, the entire disclosure of which is hereby incorporated by reference herein.

### BACKGROUND

1. Technical Field

The present invention relates to an ink for aqueous inkjet recording and an inkjet recording method and an inkjet printed matter that use the ink for aqueous inkjet recording.

2. Background Art

Since inkjet printers are relatively quiet, enjoy low running costs, and easily capable of printing color images, they are now widely used at home as output devices of digital signals.

In recent years, inkjet technologies have been appealing in business field of, for example, display, posters, and signboards in addition to home use. In such industrial use, since porous recording media have problems with regard to light resistance, water resistance, and abrasion resistance, non-porous recording media such as plastic film are used.

Accordingly, ink for such non-porous recording medium has been developed. For example, as such ink, solvent-based inkjet ink using an organic solvent as a vehicle or ultraviolet-curable inkjet ink using a polymerizable monomer as its main component have been widely used.

However, the solvent-based inkjet ink evaporates a large amount of the solvent into air, which is not preferable in terms of environmental burden. Moreover, some ultraviolet curable inkjet ink have skin sensitization potential. In addition, since an ultraviolet ray irradiator built into a printer is expensive, the application field of the solvent-based inkjet is limited.

Considering this background, development of an aqueous ink for inkjet recording that is less burden on environment and can be directly printed on a non-porous substrate (non-porous recording medium) is in progress. However, such aqueous inks have disadvantages with regard to image quality in comparison with a solvent-based inkjet ink.

First, most non-porous substrates have extremely high gloss. For this reason, unless printed portions have gloss matching with the gloss of non-printed potions, obtained printed matters lose a sense of unity. As a result, high gloss ink is demanded but aqueous ink is inferior to solvent-based inkjet ink with regard to gloss of printed matters.

In addition, printed matters for outdoor use is demanded to have extremely high strength. In addition, the needs of market for water resistance, ethanol resistance, and scratch resistance are also high, which are not satisfied yet. Furthermore, in addition to characteristics of ink after the ink lands on a recording medium, the stability of ink before being discharged, that is, ink durable to drying at nozzle surfaces, is demanded but not satisfying yet.

Studies about aqueous acrylic-modified polyurethane resins have been made so far.

However, no ink for aqueous inkjet recording having a high gloss, strength for outdoor use, and a high discharging reliability is obtained when images are printed on a non-porous substrate.

### SUMMARY

The present invention provides an improved ink for aqueous inkjet recording that contains water, a hydrosoluble organic solvent; a pigment; and an acrylic-modified polycarbonate-based urethane resin. The acrylic-modified polycarbonate-based urethane resin contains at least one of an acrylic monomer, a methacrylic monomer, and an alkylester thereof as components.

### DETAILED DESCRIPTION

The present invention is to provide ink for aqueous inkjet recording having high gloss, good scratch resistance, and good ethanol resistance at imaged portions when images are printed with the ink on a non-porous substrate such as plastic film, and in addition, excellent storage stability and excellent discharging stability of the ink over time.

The problems mentioned above is solved by the following 1.

1. Ink for aqueous inkjet recording contains water, a hydrosoluble organic solvent; a pigment; and an acrylic-modified polycarbonate-based urethane resin. The acrylic-modified polycarbonate-based urethane resin contains at least one of an acrylic monomer, a methacrylic monomer, and an alkylester thereof as components.

The present invention is described in detail of the present invention 1. Since the following 2 to 7 are included in the embodiments of the present invention, these are also described.

2. In the ink for aqueous inkjet recording mentioned above, the alkyl ester contains a methacrylic acid alkyl ester having one to four carbon atoms.

3. In the ink for aqueous inkjet recording mentioned above, the polycarbonate-based urethane resin particles has a structure derived from at least one kind of alicyclic diisocyanate.

4. In the ink for aqueous inkjet recording mentioned above, the hydrosoluble organic solvent contains at least one of 1,2-propane diol, 1,3-propane diol, 1,2-butane diol, 1,3-butane diol, and 2,3-butane diol.

5. An inkjet recording method includes printing an image with the ink for aqueous inkjet recording mentioned above.

6. The inkjet recording method mentioned above further includes heating after the step of printing.

7, An inkjet printed matter has a recording medium and an image formed on the recording medium by using the ink for aqueous inkjet recording mentioned above.

The present inventors have widely investigated resin emulsions on market and manufactured and evaluated inks for aqueous inkjet recording. As a result, the present inventors have found that ink having a high film-forming property is obtained when a polycarbonate-based urethane resin is used. The present inventors inferred that this mechanism is ascribable to polycarbonate-based urethane resins having excellent water resistance, heat resistance, and weatherability because of high agglomeration force of a carbonate group while having good drawability and flexibility, excellent attachability to a substrate at the same time.

However, alcohol resistance is not sufficient and in addition, discharging stability tends to he adversely affected as ink for ink jet recording.

Also, it is found that, although acrylic acid or methacrylic acid (hereinafter referred to as (meth)acrylic acid) based resins have disadvantages in terms of obtaining good elasticity and attachability, a hard and durable layer is obtained.

The present inventors have manufactured and investigated ink by mixing a polycarbonate-based urethane resin and an acrylic resin emulsion and found it is not possible to form a uniform layer because the compatibility of both is not improved by changing the blending ratio and both interfere each other's dispersion system, that is, both adversely affecting each other.

Moreover, the present inventors have also investigated resins having a laminate structures, i.e., a core shell type resin in which an acrylic resin forms a core with a shell of a urethane resin and found that, since the dispersion stability of the resins themselves is low, the stability of obtained ink is low and the formed layer s not smooth, thereby failing to impart gloss.

However, when the present inventors investigated ink using an acrylic-modified polycarbonate-based urethane resin (hereinafter, referred to as urethane resin X), a strong layer having a good gloss free from the side effects described above and the discharging stability of ink was improved. Thus, the present invention was made.

The mechanism of this is not clear but it is inferred that a layer is not easily formed moderately because of an acrylic resin component contained in the molecular chain, so that stability at nozzle holes is maintained.

Furthermore, it is preferable to contain a methacrylic acid alkyl ester having an alkyl group having 1 to 4 carbon atoms as the acrylic component of the urethane resin X to improve alcohol resistance of a formed layer.

Furthermore, when the isocyanate component constituting the urethane resin X is an alicyclic diisocyanate, a formed layer is strong, which is preferable to improve scratch resistance.

Moreover, it is preferable that when at least one kind of a hydrosoluble organic solvent having an SP value less than 11 is contained in ink, the wettability of the ink to a non-porous substrate is improved so that the smoothness of a formed layer is improved, thereby improving gloss, which is preferable.

Component of Ink Composition

The compositions of the ink of the present disclosure are described next.

The ink of the present disclosure contains at least water, a hydrosoluble organic solvent, a pigment, and the urethane resin X described above. It may contain other optional components.

Acrylic-modified Polycarbonate-based Urethane Resin (Urethane Resin X)

The acrylic-modified polycarbonate-based urethane resin in the present disclosure is a polycarbonate-based urethane resin containing a (meth)acrylic acid ester component in its chemical structure.

The acrylic-modified polycarbonate-based urethane resin is preferably an acrylic-modified polycarbonate-based urethane resin having a methacrylic acid ester as a component. Another preferred example is an acrylic acid ester in addition to a methacrylic acid ester.

There is no specific limit to the method of introducing a (meth)acrylic acid component into this chemical structure. A preferred method includes conducting polymerization reaction of a mixtures of an acrylic polyol and a polycarbonate polyol with polyisocyanate when synthesizing a urethane resin in terms of easiness of manufacturing. It is preferable that acrylic polyol is from 0.1% by weight to 50% by weight to polycarbonate polyol to have good strength and attachability to a substrate simultaneously. It is more preferably from 1% by weight to 40% by weight and more from 1% by weight to 30% by weight.

The acrylic polyol mentioned above is a (meth)acrylic acid monomer having a hydroxyl group or is obtained by copolymerization of a (meth)acrylic acid monomer having a hydroxyl group and a (meth)acrylic acid ester. In the latter case, another vinyl-based monomer such as styrene can be optionally used in combination.

Specific examples of the (meth)acrylic acid monomer having a hydroxyl group include, but are not limited to, acrylic acid-2-hydroxyethyl, acrylic acid hydroxy propyl, acrylic acid-4-hydroxy butyl, methacrylic acid-2-hydroxyethyl, methacrylic acid hydroxy propyl, methacrylic acid-4-hydroxy butyl, polyethylene glycol monoacrylate, polyethylene glycol monomethacrylate, polypropylene glycol monoacrylate, polypropylene glycol monomethacrylate, polytetramethylene glycol monoacrylate, and polytetramethylene glycol monomethacrylate.

Specific examples of the (meth)acrylic acid esters include, but are not limited to. methyl(meth)acrylate, ethyl(meth)acrylate, n-propyl(meth)acrylate, i-propyl(meth)acrylate n-butyl(meth)acrylate, 1-butyl(meth)acrylate, tert-butyl(meth)acrylate, 2-ethylhexyl(meth)acrylate, nonyl(meth)acrylate, tridecyl(meth)acrylate, lauryl(meth)acrylate, stearyl(meth)acrylate, isostearyl(meth)acrylate, cyclohexyl(meth)acrylate, and methylcyclohexyl(meth)acrylate.

Of these, a methacrylic acid alkylester having an alkyl group having one to four carbon atoms is particularly preferable to improve scratch resistance and alcohol resistance of a formed resin layer. Specifically, methyl methacrylate, ethyl methacrylate, i-propyl methacrylate, and tert-butyl methacrylate are preferable.

It is possible to use as the poly-carbonate polyol mentioned above polyols prepared by, for example, ester exchange reaction of a carboxylic acid ester and a polyol under the presence of a catalyst or reaction between phosgene and bisphenol A.

Specific examples of the carboxylic acid ester mentioned above include, but are not limited, to methyl carbonate, dimethyl carbonate, ethyl carbonate, diethyl carbonate, cyclocarbonate, and diphenyl carbonate. Specific examples of the polyol mentioned above to react with the carboxylic acid ester include, but are not limited, low-molecular weight diol compounds such as ethylene glycol, diethylene glycol, 1,2,-propylene glycol, dipropylene glycol, 1,4-butane diol, 1,5-pentane diol, 3-methyl-1,5-pentane diol, neopentyl glycol, and 1,4-cyclohexane diol; polyethylene glycol, and polypropylene glycol.

There is no specific limit o the polyisocyanate mentioned above. Specific examples thereof include, but are not limited to, aromatic polyisocyante compounds such as 1,3-phenylene diisocyanate, 1,4-phenylene diisocyanate, 2,4-tolylene diisocyanate (TDI), 2,6-tolylene diisocyanate, 4,4′-diphenylene methane diisocyanate (MDI), 2,4-diphenyl methane diisocyanate, 4,4′-diisocynato biphenyl, 3,3′-dimethyl-4,4′-diisocyanate biphenyl, 3,3′-dimethyl-4,4′-diisocyanate, diphenyl methane, 1,5-naphtylene diisocyanate. m-isocyanate pheny sulphonyl isocyanate, p-isocyanate phenyl sulfonyl isocyanate, and p-isocyanate phenyl sulfonyl isocyante; aliphatic polyisocyanates compounds such as ethylene diisocyanate, tetramethylene diisocyanate, hexamethylene diisocyanate (HDI), dodecamethylene diisocyanate, 1,6,11-undecane triisocyanate, 2,2,4-trimethyl hexamethylene diisocyanate, lysine diisocyanate, 2,6-diisocyante methylcaproate, bis(2-isocyanate ethyl)fumarate, bis(2-isocyanateethyl)carbonate, and 2-isocyanate ethyl-2,6-diisocyanate hexanoate; and alicyclic polycyanate compounds such as isophorone diisocyante (IPDI), 4,4′dicyclohexyl methane diisocyanate (hydrogenated MDI), cyclohexylene diisocyante, methylcyclohexylene diisocyanate (hydrogenated TDI), bis(2-isocyanatecthyl)-4-dichlorohexene-1,2-dicarboxylate, 2,5-norbornane diisocyante, and 2,6-norbonane diisocyante.

These can be used alone or in combination.

The ink of the present disclosure is expected to be applied to posters, signboards, etc., for outdoor use, so that an applied layer having an extremely high long weather resistance is demanded. In terms of this, using aliphatic or alicyclic diisocyanates is preferable.

Furthermore, it is preferable to add at least one kind of alicyclic diisocyanate, thereby easily acquiring a desired layer strength.

In particular, isophrone diisocyanate and dicyclohexyl methane diisocyanate are preferable. The ratio of alicyclic diisocyanate is preferably 60% by weight or more in all of isocyanate compounds.

As for the ink of the present disclosure, urethane resin X is added in a form of a resin emulsion in which urethane resin X is is dispersed in an aqueous medium. The ratio of the resin solid portion in the resin emulsion is preferably 20% by weight or more to improve the freedom of prescription designing of ink.

Urethane resin X preferably has a volume average particle diameter of from 10 nm to 350 nm in light of liquid storage stability and discharging stability when ink is prepared.

In addition, when dispersing urethane resin X in an aqueous medium, it is possible to use a forcible emulsification type using a dispersant. However, since such a dispersant tends to remain in a layer (film), thereby weakening the layer, a so-called self-emulsification type, which has anionic property in its molecule structure, is preferable.

If an anionic group is contained in an acid value range of from 5 mgKOH to 100 mgKOH/g, it is preferable in terms of hydrodispersability. To impart excellent scratch resistance and chemical resistance, it is particularly preferable that the acid value ranges from 5 mgKOH to 50 mgKOH/g.

In addition, it is possible to obtain good hydrodispersibility by using carboxylic group, sulfonic acid group, etc. as anionic group. To introduce an anionic group into a resin, it is suitable to use a monomer having such an anionic group.

Specific examples such monomers include, but are not limited to, monohydroxycarboxylic acids such as lactic acid; dihydroxy carboxylic acids such as α,α-dimethylol acetic acid, α,α-dimethylol propionic acid, and α,α-dimethylol lactic acid: and diaminosulfonic acid such as 3,4-diaminobutane sulfonic acid, and 3,6-diamino-2-toluene sulfuric acid.

Specific examples of the basic compound to neutralize the anionic group include, but are not limited to, organic amines such as ammonium, triethyl amine, pyridine, and morpholine, alkanol amine such as monoethanol amine, and metal salt compounds containing Na, K, Li, Ca, etc.

When using a forcible emulsification method, a nonion surfactant or anion surfactant can be used. Of these, a nonion surfactant is preferable in terms of water resistance.

Specific examples of nonion surfactants include, but are not limited to, polyoxyethylene alkyl ether, polyoxyethylene alkylene alkyl ether, polyoxyethylene derivatives, polyoxyethylene aliphatic acid esters, polyoxyethylene polol alicphatic acid ester, polyoxyethylene propylene polyol, sorbitan aliphatic acid ester, polyoxyethylene curable acinus, polyoxyalkylene polycyclic phenyl ether, polyoxyethylene alkyl amine, alkyl alkanol amide, and polyalkylene glycol(meth)acrylate. Of these, polyoxyethylene alkyl ether, polyoxyethylene aliphatic acid esters, polyoxyethylene sorbitan aliphatic acid ester, and polyoxyethylene alkyl amine are preferable.

Specific examples of anionic surfactants include, but are not limited to, alkyl sulfuric acid ester salts, polyoxyethylene alkyl ether sulfuric acid salts, alkyl benzene sulfonic acid salts, α-olefine sulfonic acid salts, methyl lauryl acid salts, sulfosuccinic acid salts, ether sulfonic acid salts, ether carboxylic acid salts, aliphatic acid salts, naphthalene sulfonic acid formalin condensed compounds, alkyl amine salts, quaternary ammonium salts, alkyl betaine, and alkyl amine oxide. Polyoxyethylene alkyl ether sulfuric acid salts and sulfosuccinic salts are preferable.

The addition amount of a surfactant is from 0.1% by weight to 30% by weight and preferably from 5% by weight to 20% by weight to the amount of urethane resin. When it is less than 0.1% by weight, the addition effect of a surfactant is not easily demonstrated.

When it surpasses 30% by weight, an emulsifying agent is added excessively to form a urethane resin emulsion, thereby extremely degrading attachability and water resistance, so that when a formed layer becomes dry, plasticizing effect and bleeding phenomenon tend to occur, which leads to blocking. This is not preferable.

Moreover, optionally a hydrosoluble organic solvent, an antiseptic agent, a leveling agent, an antioxidant, a light stabilizer, and an ultraviolet absorbent can be blended with a urethane resin emulsion,

There is no specific limit to the manufacturing method of the urethane resin X. Any conventional method is suitable. That is, it is suitable to react a mixture of a polycarbonate polyol and an acrylic polyol with a polyisocyanate at once or in multiple steps.

In addition, synthesis of a polyurethane resin is convenient to conduct in an organic solvent inert to isocyanate group.

An example of the synthesis method is as follows.

First, under the presence of no solvent or an organic solvent, a urethane prepolymer having an isocyanate group at its end is prepared by reacting a mixture of a polycarbonate polyol and an acrylic polyol with a polyisocyanate with an equivalent ratio in which an isocyanate group is excessive.

Next, optionally, the anionic group in the urethane prepolymer having an isocyanate group at its end is neutralized by a neutralizer. Subsequent to reaction with a chain elongating agent, the organic solvent in the system is removed to obtain polycarbonate-based urethane resin particles.

Specific examples of usable organic solvents include, but are not limited to, ketone such as aetone and methyl ethyl ketone; ethers such as tetrahydrofuran and dioxane, acetic acid esters such as ethyl acetate and butylacetate, nitriles such as acetonitrile, dimethyl formamide, N-methyl pyrrolidone, and N-ethyl pyrrolidone. These can be used alone or in combination.

Polyamines or other compounds having active hydrogen atom are used as the chain elongating agent.

Specific examples of the polyamine include, but are not limited to, diamines such as ethylene diamine, 1,2-propane diamine, 1,6-hexamethylene diamine, piperazine, 2,5-dimethyl piperazine, isophorone diamine, 4,4′-dicyclohexyl methane diamine, 1,4-cyclohexane diamine, polyamines such as diethylene triamine, dipropylene triamine, and triethylene tetramine, hydrazines such as hydrazine, N,N′-dimethyl hydrazine, and 1,6-hexamethylene his hydrazine; dihydrazides such as succinic acid dihydrazide, adipic acid dihydrazide, glutaric acid dihydrazide, sebacic acid dihydrazide, and isophthalic acid dihydrazide.

Specific examples of the other active hydrogen containing compounds include, but are not limited to,glycols such as ethylene glycol, diethylene glycol, triethylene glycol, propylene glycol, 1,3-propane diol, 1,3-butane diol, 1,4-butane diol, hexamethylene saccharose, methylene glycol, glycerin, and sorbitol; phenols such as bisphenol A, 4,4′-duhydroxydiphenyl, 4,4′-dihydroxydiphenyl ether, 4,4′-dihydroxydiphenyl sulfone, hydrogenated bisphenol A, and hydroquinoe, and water.

These can be used alone or in combination,

If the ink of the present disclosure is dried by heating after printing, the amount of residual solvent is decreased, thereby improving attachability, which is preferable. Since urethane resin X has a good heat resistance so that the ink can be dried by heating without a problem.

It is not always necessary that the lowest layer forming temperature of urethane resin X is room temperature or lower. However, if dried by heating, it is preferable that the lowest layer forming temperature is not higher than the heating temperature after printing.

The lower the lowest layer forming temperature of urethane resin X, the more excellent the layer forming property. However, when the lowest layer forming temperature is too low, the glass transition temperature of the resin lowers so that the strength of a formed layer is insufficient. Accordingly, it is preferably 0° C. or higher and more preferably 20° C. or higher,

When the lowest layer forming temperature is too high, a resin layer may not be sufficiently formed. Therefore, it is preferable that the lowest layer forming temperature is preferably 5° C. or greater lower and more preferably 10° C. or greater lower than the drying temperature in the heating and drying process.

The lowest layer forming temperature is the lowest temperature below which transparent continuous film is not formed when an emulsion is extended and flown on a metal plate made of made of such as aluminum while raising the temperature. At temperatures lower than the lowest layer forming temperature, the emulsion becomes white powder.

The urethane resin X preferably has a surface hardness of 100 N/mm² or greater. In this range, ink forms a strong layer, which leads to improvement of scratch resistance.

The surface hardness is measured by the following method:

After applying an emulsion of urethane resin X to a glass slide to form a layer having a thickness of 10 μm, the resin emulsion is dried at 100° C. for 30 minutes to form a resin layer. Using a micro surface hardness tester (FISCHERSCOPE HM2000, manufactured by Fischer Instruments K.K. Japan), the pressed-in depth when a Berkovich indenter is pressed in under a load of 9.8 mN is obtained, which is measured as Martens hardness described in lSO14577-2002.

The addition amount of the urethane resin X in the ink of the present disclosure is preferably from 0.5% by weight to 15% by weight, more preferably from 1% by weight to 10% by weight, and furthermore preferably from 2% by weight to 9% by weight in solid portion conversion.

When the addition amount is less than 0.5% by weight, image toughness s inferior because a layer is not sufficiently formed to pigment. When the addition amount is greater than 15% by weight, viscosity becomes excessively high, thereby making it difficult to discharge ink.

The ink of the present disclosure optionally contains a resin other than the urethane resin X. However, the urethane resin X preferably accounts for 50% by weight or more and more preferably 70% by weight or more to the optionally added resin.

Specific examples of the optional resin include, but are not limited to, acrylic resins, polyolefin resins, vinyl acetate resins, vinyl chloride resins, fluorine-containing resins, polyether resins, and polyester resins.

Pigment

As inorganic pigments, in addition to titanium oxide, iron oxide, calcium oxide, barium sulfate, aluminum hydroxide, barium yellow, cadmium red, and chrome yellow, carbon black manufactured by known methods such as contact methods, furnace methods, and thermal methods can be used.

As the organic pigments, azo pigments (azo lakes, insoluble azo pigments, condensed azo pigments, chelate azo pigments, etc.), polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinofuranone pigments, etc.), dye chelates (basic dye type chelates, acid dye type chelates), nitro pigments, nitroso pigments, and aniline black can be used.

Of these pigments, pigments having good affinity with solvents are preferable in particular.

Preferred specific examples of the pigments for black include, but are not limited to, carbon black (C.I. Pigment Black 7) such as furnace black, lamp black, acetylene black, and channel black, metals such as copper and iron (C.I. Pigment Black II), metal oxides compounds such as titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 128, 138, 150, 151, 153, and 183; C.I. Pigment Orange 5, 13, 16, 17, 36, 43, and 51; C.I. Pigment Red 1, 2, 3, 5, 7, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 185, 190, 193, 209, and 219; C.I. Pigment Violet I (Rohdamine Lake), 3, 5:1, 16, 19, 23, and 38; C.I. Pigment Blue 1, 2, 15 (Phthalocyanine Blue), 15:1, 15:2, 15:3 (Phthalocyanine Blue), 16, 17:1, 56, 60, and 63; and C.I. Pigment Green 1. 4, 7, 8, 10, 17, 18, and 36.

A pigment can he dispersed in ink by a dispersion method using a surfactant, a dispersion method using a dispersible resin, a dispersion method of coating the surface of pigment with a resin, and a dispersion method of forming a self-dispersible pigment by introducing a hydrophilic group into the surface of a pigment.

To disperse a pigment using a dispersant, known dispersants can be used. For example, dispersion polymers or hydrosoluble surfactant.

The surface area of a pigment is preferably from about 10 m²/g to about 1,500 m²/g, more preferably from about 20 m²/g to about 600 m²/g, and furthermore preferably about 50 m²/g to about 300 m²/g. Unless a pigment has such a desired surface area, it is suitable to reduce the size of the pigment or pulverize it by using, for example, a ball mill, a jet mill, or ultrasonic wave to have a relatively small particle diameter.

The volume average particle diameter (D50) of the pigment in ink is preferably from 10 nm to 200 nm and more preferably from 20 nm to 150 nm.

When the particle diameter surpasses 200 nm, the dispersion stability of pigment in ink tends to be worsened and in addition, discharging stability tends to deteriorate, thereby degrading image quality such as image density. In addition, when the particle diameter is less than 10 nm, storage stability of ink and discharging properties at a printer are good.

However, dispersion operation and classification operation become complicated to obtain a smaller particle size, which makes it difficult to economically manufacture ink.

The addition amount of the pigment in ink is preferably from about 0.1% by weight to about 10% by weight and more preferably from about 1% by weight to about 10% by weight. As pigment concentration increases, image density increases so that image quality is improved. However, reliability on fixability, discharging stability, and clogging tends to deteriorate.

Hydrosoluble Organic Solvent

There is no specific limit to the hydrosoluble organic solvent for use n the ink of the present disclosure.

Specific examples of the hydrosoluble organic solvent include, but are not limited to, polyols such as ethylene glycol, diethylene glycol, 1.2-propane diol, 1,3-propane diol, 1,2-butane diol, 1,3-butane diol, 2,3-butane diol, 3-methyl-1,3-butane diol, triethylene glycol, polyethylene glycol, polypropylene glycol, dipropylene glycol, tripropylene glycol, polypropylene glycol, 1,5-pentane diol, 1,6-hexane diol, 2-ethyl-1,3-hexane diol, glycerin, 1,2,6-hexane triol, ethyl-1,2,4-butane triol. 1,2,3-hbutane triol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethylimidazolidinone, ε-caprolactam, and γ-butyrolactone; amides such as formamide, N-methylfomamide, and N,N-dimethylformamide; amines such as monoethanolamine, diethanolamine, triethanolamine, monoethylamine, diethylamine, and triethylamine; sulfur-containing compounds such as dimethyl sulfoxide, sulfolane, and thiodiethanol; propylene carbonate, and ethylene carbonate.

Of these, in terms of the compatibility with the urethane resin X and obtaining ink having a good layer forming property; 1,2-propane diol, 1,3-propane diol, 1,2-butane diol, 1,3-butane diol, and 2,3-propane diol are particularly preferable to obtain excellent image gloss.

The total amount of the hydrosoluble organic solvent in ink is preferably from 20% by weight to 70% by weight and more preferably from 30% by weight to 60% by weight. When the total amount is less than 20% by weight, ink tends to be dried, which may lead to failure to obtain sufficient discharging stability. When the total amount is greater than 70% by weight, viscosity tends to become high, thereby failing to discharge ink.

As for the ink of the present disclosure, a surfactant can be added so as to secure wettability to a recording medium.

The addition amount of a surfactant to ink is preferably from 0.1% by weight to 5% by weight therein. When the addition amount is less than 0.1% by weight, wettability to a non-porous substrate tends to be insufficient, thereby degrading image quality. When the addition amount is greater than 5% by weight, ink tends to foam, leading to occurrence of non-discharging.

If the conditions described above are met, there is no specific limit to the kind of surfactant to be used and an amphoteric surfactant, a nonionic surfactant, and an anionic surfactant are usable. Considering the relation between the dispersability of a coloring material and image quality, nonionic surfactants are preferable such as polyoxyethylene alkyl phenyl ether, polyoxyethylene alkyl ester, polyoxyethylene alkyl amine, polyoxyethylene alkyl amide, polyoxyethylene propylene block polymer, sorbitan aliphatic esters, polyoxyethylene sorbitan aliphatic acid esters, and adducts of acetylene alcohol with ethylene oxides. In addition, it is possible to add a fluorine-containing surfactant and/or silicone-based surfactant depending on prescription.

Other Components

Examples of other additives include preservatives and fungicides, corrosion inhibitors, and pH regulators.

Specific examples of preservatives and fungicides include, but are not limited to, 1,2-benzisothiazoline-3-on, sodium benzoate, dehydrosodium acetate, sodium sorbate, pentachlorophenol sodium, and 2-pyridine thiol-1-oxide sodium.

Specific examples of the corrosion inhibitors include, but are not limited to, acid sulfite, thiosodium sulfate, ammonium thiodiglycolate, diisopropyl ammonium nitrite, pentaerythritol tetranitrate, and dicyclohexyl ammonium nitrite.

There is no specific limit to pH adjustment agents if it can adjust pH to a desired value without an adverse impact on prescribed ink. Specific examples thereof include, but are not limited to, hydroxides of alkali metal elements such as lithium hydroxide, sodium hydroxide, and potassium hydroxide; carbonates of alkali metals such as lithium carbonate, sodium carbonate, and potassium carbonate; hydroxides of quaternary ammonium, amines such as diethanol amine and triethanol amine; ammonium hydroxide, and hydroxides of quaternary phosphonium.

There is no specific limit to the manufacturing method of the ink of the present disclosure. For example, it can be manufactured by dissolving or dispersing the ink composition mentioned above in an aqueous medium followed by optional mixing and stirring. Mixing and stirring can be conducted by a typical stirrer using a stirring wing, a magnetic stirrer, a high performance disperser, etc.

The inkjet recording method of the present disclosure includes image forming steps of at least applying a stimulus (energy) to the ink of the present disclosure to discharge the ink to form an image on a recording medium.

Various known inkjet recording methods can be applied to the inkjet recording method in the image forming step. For example, there are an inkjet recording method employing scanning heads and an inkjet recording method of recording an image on a sheet-like printing paper using lined heads.

There is no specific limitation to the system of driving a recording head serving as the ink discharging device in the image forming process. For example, a piezoelectric element actuator using PZT, etc., a system of using a thermal energy, an on-demand type recording head using an actuator, etc. utilizing an electrostatic force, and a charge control type recording head employing continuous spraying system can be used to record images.

The inkjet recording method of the present disclosure preferably includes a heating and drying process to heat and dry a recording medium after printing in order to form an image with higher quality, abrasion resistance, and attachability and demonstrate high performance under high speed printing conditions. In addition, it is possible to suitably select and use a known heating device. For example, devices for forced-air heating, radiation heating, conduction heating, or microwave drying can be used.

These can he used alone or in combination.

The heating temperature can be changed depending on the kind and amount of a hydrosoluble organic solvent contained in ink and the lowest layer forming temperature of an added urethane resin X emulsion. It also can be changed depending on the kind of printed substrate. The heating temperature is preferably high in terms of quick drying and layer forming temperature. If the heating temperature is too high, a substrate on which an image is printed is damaged or an ink head is heated, thereby causing undischarging. This is not preferable.

The ink printed matter of the present disclosure is obtained by the inkjet recording method of the present disclosure. Therefore, an image formed with the ink of the present disclosure is formed on a recording medium.

There is no specific limit to the recording medium so that images can be formed on plain paper, gloss paper, special paper, cloth, etc. Images formed on a non-porous substrate by using the ink of the present disclosure particularly have good gloss and image strength.

This non-porous substrate is formed of plastic materials such as transparent or colored vinyl chloride film, polyethylene terephthalate (PET), acrylic film, polypropylene film, polyimide film, and polystyrene film, without containing paper components such as wood pulp paper, Japanese paper, synthesized pulp paper, and synthesized fiber paper.

Of these non-porous substrates, plastic films of polyvinyl chloride resin (PVC), polyethylene terephthalate (PET) film, polycarbonate film, etc. are suitably used. However, the ink of the present disclosure is suitable for other non-porous substrates and conventionally used porous media such as plain paper or inorganic coated porous media.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present invention is described in detail with reference to Examples and Comparative Examples but not limited thereto. “Parts” in Examples represent “parts by weight”.

Preparation of Urethane Resin X Emulsion A

1,500 g of polycarbonate diol (reaction product of 1,6-hexane diol and dimethyl carbonate), 100 g of acrylic polyol (copolymers of metherylic acid-2-hydroxyethyl and methyl methacrylate), 220 g of 2,2-dimethylol propionic acid (DMPA), and 1,347 g of N-methyl pyrrolidone (NMP) were placed in a reaction container equipped with a stirrer, a reflux cooling tube, and a thermometer in a nitrogen atmosphere followed by heating to 60° C. to dissolve DMPA. Thereafter, 1,445 g of 4,4′-dicyclohexyl methane diisocyanate and 2.6 g of dibutyl tin dilaurylate (catalyst) were added followed by heating to 90° C. to conduct urethanification reaction in five hours, thereby obtaining an urethane prepolymer having an isocyanate group at its end. This reaction mixture was cooled down to 80° C. 149 g of triethylamine was admixed therewith. 4,340 g was extracted from the admixed mixture and added to a liquid mixture of 5,400 g of water and 15 g of triethyl amine while being vigorously stirred. Thereafter, 1,500 g of ice and 626 g of 35% by weight 2-methyl-1,5-pentane diamine aqueous solution were added to conduct chain elongation reaction followed by distillation away of the solvent in such a manner that the solid portion concentration was 30% by weight to obtain urethane resin X emulsion a.

Preparation of Urethane Resin X Emulsion B

Urethane resin X emulsion b was obtained in the same manner as in manufacturing of urethane resin X emulsion a except that 4,4′-dicyclohexyl methane diisocyanate was changed to a mixture of isophorone diisocyanate and dodeca methylene diisocyanate with a molar ratio of 6 to 4.

Preparation of Urethane Resin X Emulsion C

Urethane resin X emulsion c was obtained in the same manner as in manufacturing of urethane resin X emulsion a except that the acrylic polyol was changed to a copolymer of acrylic acid-2-hydroxyethyl and methacrylic acid-2-ethylhexyl.

Preparation of Urethane Resin X Emulsion D

Polycarbonate-based urethane resin emulsion d was obtained in the same manner as in the preparation of the emulsion a except that 4,4′-dicyclohexyl methane diisocyanate was changed to hexamethylene diisocyanate.

Preparation of Polycarbonate-based Urethane Resin Emulsion E

Polycarbonate-based urethane resin emulsion e was obtained in the same manner as in the preparation of the emulsion a except that no acrylic polyol was added.

Preparation of Acrylic Resin Emulsion F

1,000 g of methylethyl ketone was placed in a flask equipped with a dripping funnel, a thermometer, a nitrogen-introducing tube, a stirrer, and a reflux condenser and heated to 78° C. Thereafter, a liquid mixture of 700 g of n-butylmethacrylate, 42 g of n-butylacrylate, 150 g of 2-hydroxy ethylmethacrylate, 108 g of metharylic acid, and 80 g of t-butylperoxy-2-ethylhexanoate was dripped to the flask in four hours followed by reaction at the same temperature for eight hours. Subsequent to cooling down to room temperature, methylethyl ketone was added to the reaction mixture for dilution in such a manner that non-volatile portions accounted for 50% by weight to obtain a polymer solution. After 28 g of this polymer solution, 13.6 g of 1 mol/L potassium hydroxide solution, 20 g of methylethyl ketone, and 30 g of deionized water were sufficiently stirred, the mixture was mixed and kneaded using a three-roll mill. The thus-obtained paste was placed in 200 g of deionized water. Subsequent to sufficient stirring, methylethyl ketone and water were distilled away by an evaporator in such a manner that solid portion concentration accounted for 40% by weight. Furthermore, coarse particles were removed by a filter (acetyl cellulose membrane) having an opening size of 5 μm to obtain an acrylic resin emulsion f.

Preparation of Acrylic-modified Polyether-based Resin Emulsion g

Acrylic-modified polyester-based resin emulsion g was obtained in the same manner as in the preparation of the emulsion a except that polycarbonate diol was changed to polypropylene glycol.

### Example 1

After preliminarily mixing the following recipe, a liquid dispersion 1 of pigment was obtained by conducting circulation dispersion for seven hours by a disk-type bead mill (KDL type, manufactured by SHINMARU ENTERPRISES CORPORATION; Media: zirconia ball having a diameter of 0.3 mm).

| | |
|---|---|
| Carbon black pigment (Monarch 800, manufactured | 15 parts |
| by Cabot Corporation): | |
| Anionic surfactant (Pionine A-51-B, manufactured | 2 parts |
| by TAKEMOTO OIL & FAT Co., Ltd.): | |
| Deionized water | 83 parts |

The following recipe containing the liquid dispersion 1 of pigment was mixed and stirred and thereafter filtered by a polypropylene filter of 0.2 μm to prepare ink.

| | |
|---|---|
| Liquid dispersion 1 of pigment: | 20 parts |
| Preparation of Urethane Resin X Emulsion a: | 15 parts |
| Surfactant CH₃(CH₂)₁₂O(CH₂CH₂O)₃CH₂COOH: | 2 parts |
| 1,2-propane diol: | 20 parts |
| Diethylene glycol-n-butyl ether: | 10 parts |
| Preservatives and fungicides (PROXEL LV, manufactured | 0.1 parts |
| by AVECIA GROUP): | |
| Deionized water | 32.9 parts |

### Example 2

A liquid dispersion 2 of pigment was manufactured in the same manner as in the preparation of liquid dispersion 1 of pigment of Example 1 except that the pigment was changed to pigment blue 15:3.

The following recipe containing the liquid dispersion 2 of pigment was mixed and stirred and thereafter filtrated by a polypropylene filter of 0.2 μm to prepare ink.

| | |
|---|---|
| Liquid dispersion 2 of pigment: | 20 parts |
| Preparation of Urethane Resin X Emulsion a: | 15 parts |
| Surfactant CH₃(CH₂)₁₂O(CH₂CH₂O)₃CH₂COOH: | 2 parts |
| 1,3-propane diol: | 20 parts |
| Ethylene glycol-n-hexyl ether: | 10 parts |
| Preservatives and fungicides (PROXEL LV, manufactured | 0.1 parts |
| by AVECIA GROUP): | |
| Deionized water | 32.9 parts |

### Example 3

A liquid dispersion 3 of pigment was manufactured in the same manner as in the preparation of liquid dispersion 1 of pigment of Example 1 except that the pigment was changed to pigment red 122.

The following recipe containing the liquid dispersion 3 of pigment was mixed and stirred and thereafter filtered by a polypropylene filter of 0.2 μm to prepare ink.

| | |
|---|---|
| Liquid dispersion 3 of pigment: | 20 parts |
| Preparation of Urethane Resin X Emulsion b: | 15 parts |
| Surfactant CH₃(CH₂)₁₂O(CH₂CH₂O)₃CH₂COOH: | 2 parts |
| 1,2-butane diol: | 20 parts |
| Diethylene glycol-n-butyl ether: | 10 parts |
| Preservatives and fungicides (PROXEL LV, manufactured | 0.1 parts |
| by AVECIA GROUP): | |
| Deionized water | 32.9 parts |

### Example 4

A liquid dispersion 4 of pigment was manufactured in the same manner as in the preparation of liquid dispersion 1 of pigment of Example 1 except that the pigment was changed to pigment yellow 74.

The following recipe contain liquid dispersion 4 of pigment a mixed and stirred and thereafter filtered by a polypropylene filter of 0.2 μm to prepare ink.

| | |
|---|---|
| Liquid dispersion 4 of pigment: | 20 parts |
| Preparation of Urethane Resin X Emulsion b: | 15 parts |
| Surfactant CH₃(CH₂)₁₂O(CH₂CH₂O)₃CH₂COOH: | 2 parts |
| 2,3-butane diol: | 20 parts |
| Ethylene glycol-n-hexyl ether: | 10 parts |
| Preservatives and fungicides (PROXEL LV, manufactured | 0.1 parts |
| by AVECIA GROUP): | |
| Deionized water | 32.9 parts |

### Example 5

Using the same liquid dispersion 1 of pigment as Example 1, the following recipe was mixed and stirred and thereafter filtrated by a polypropylene filter of 0.2 μm to prepare ink.

| | |
|---|---|
| Liquid dispersion 1 of pigment: | 20 parts |
| Preparation of Urethane Resin X Emulsion a: | 15 parts |
| Surfactant CH₃(CH₂)₁₂O(CH₂CH₂O)₃CH₂COOH: | 2 parts |
| 1,3-butane diol: | 20 part |
| Diethylene glycol-n-butyl ether: | 10 parts |
| Preservatives and fungicides (PROXEL LV, manufactured | 0.1 parts |
| by AVECIA GROUP): | |
| Deionized water | 32.9 parts |

### Example 6

Using the same liquid dispersion 1 of pigment as Example 1, the following recipe was mixed and stirred and thereafter filtrated by a polypropylene filter of 0.2 μm to prepare ink.

| | | |
|---|---|---|
| Liquid dispersion 1 of pigment: | 20 | parts |
| Urethane Resin X Emulsion c | 15 | parts |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, manufactured | 0.1 | parts |
| by AVECIA GROUP): | | |
| Deionized water | 32.9 | parts |

### Example 7

Using the same liquid dispersion 2 of pigment as Example 2, the following recipe was mixed and stirred and thereafter filtrated by a polypropylene filter of 0.2 μm to prepare ink.

| | | |
|---|---|---|
| Liquid dispersion 2 of pigment: | 20 | parts |
| Urethane Resin X Emulsion c | 15 | parts |
| Surfactant CH₃(CH₂)₁₂O(CH₂CH₂O)₃CH₂COOH: | 2 | parts |
| 1,3-propane diol: | 20 | parts |
| Ethylene glycol-n-hexyl ether: | 10 | parts |
| Preservatives and fungicides (PROXEL LV, manufactured | 0.1 | parts |
| by AVECIA GROUP): | | |
| Deionized water | 32.9 | parts |

### Example 8

Using the same liquid dispersion 3 of pigment as Example 3, the following recipe was mixed and stirred and thereafter filtrated by a polypropylene filter of 0.2 μm to prepare ink.

| | | |
|---|---|---|
| Liquid dispersion 3 of pigment: | 20 | parts |
| Urethane Resin X Emulsion d: | 15 | parts |
| Surfactant CH₃(CH₂)₁₂O(CH₂CH₂O)₃CH₂COOH: | 2 | parts |
| 1,2-butane diol: | 20 | parts |
| Diethylene glycol-n-butyl ether: | 10 | parts |
| Preservatives and fungicides (PROXEL LV, manufactured | 0.1 | parts |
| by AVECIA GROUP): | | |
| Deionized water | 32.9 | parts |

### Example 9

Using the same liquid dispersion 4 of pigment as Example 4, the following recipe was mixed and stirred and thereafter filtrated by a polypropylene filter of 0.2 μm to prepare ink.

| | | |
|---|---|---|
| Liquid dispersion 4 of pigment: | 20 | parts |
| Urethane Resin X Emulsion d: | 15 | parts |
| Surfactant CH₃(CH₂)₁₂O(CH₂CH₂O)₃CH₂COOH: | 2 | parts |
| 2,3-butane diol: | 20 | parts |
| Ethylene glycol-n-hexyl ether: | 10 | parts |
| Preservatives and fungicides (PROXEL LV, manufactured | 0.1 | parts |
| by AVECIA GROUP): | | |
| Deionized water | 32.9 | parts |

### Example 10

Using the same liquid dispersion 1 of pigment as Example 1, the following recipe was mixed and stirred and thereafter filtrated by a polypropylene filter of 0.2 μm to prepare ink.

| | | |
|---|---|---|
| Liquid dispersion 1 of pigment: | 20 | parts |
| Preparation of Urethane Resin X Emulsion a: | 15 | parts |
| Surfactant CH₃(CH₂)₁₂O(CH₂CH₂O)₃CH₂COOH: | 2 | parts |
| 1,4-butane diol: | 20 | parts |
| Diethylenc glycol-n-butyl ether: | 10 | parts |
| Preservatives and fungicides (PROXEL LV, manufactured | 0.1 | parts |
| by AVECIA GROUP): | | |
| Deionized water | 32.9 | parts |

### Example 11

Using the same liquid dispersion 2 of pigment as Example 2, the following recipe was mixed and stirred and thereafter filtrated by a polypropylene filter of 0.2 μm to prepare ink.

| | | |
|---|---|---|
| Liquid dispersion 2 of pigment: | 20 | parts |
| Preparation of Urethane Resin X Emulsion a; | 15 | parts |
| Surfactant CH₃(CH₂)₁₂O(CH₂CH₂O)₃CH₂COOH: | 2 | parts |
| 3-methyl-1,3-butane diol: | 20 | parts |
| Ethylene glycol-n-hexyl ether: | 10 | parts |
| Preservatives and fungicides (PROXEL LV, manufactured | 0.1 | parts |
| by AVECIA GROUP): | | |
| Deionized water | 32.9 | parts |

### Example 12

To evaluate scratch damage and ethanol resistance of the ink of Example 1, the drying condition of 80° C. for one hour was changed to 25° C. for one light.

### Comparative Example 1

Using the same liquid dispersion 1 of pigment as Example 1, the following recipe was mixed and stirred and thereafter filtrated by a polypropylene filter of 0.2 μm to prepare ink.

| | | |
|---|---|---|
| Liquid dispersion 1 of pigment: | 20 | parts |
| Polycarbonate-based Urethane Resin Emulsion e: | 15 | parts |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, manufactured | 0.1 | parts |
| by AVECIA GROUP): | | |
| Deionized water | 32.9 | parts |

### Comparative Example 2

Using the same liquid dispersion 1 of pigment as Example 1, the following recipe was mixed and stirred and thereafter filtrated by a polypropylene filter of 0.2 μm to prepare ink.

| | | |
|---|---|---|
| Liquid dispersion 1 of pigment: | 20 | parts |
| Polycarbonate-based Urethane Resin Emulsion e: | 15 | parts |
| Acrylic Resin Emulsion f: | 5 | parts |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, manufactured | 0.1 | parts |
| by AVECIA GROUP): | | |
| Deionized water | 32.9 | parts |

### Comparative Example 3

Using the same liquid dispersion 1 of pigment as Example 1, the following recipe was mixed and stirred and thereafter filtrated by a polypropylene filter of 0.2 μm to prepare ink.

| | | |
|---|---|---|
| Liquid dispersion 1 of pigment: | 20 | parts |
| Polycarbonate-based Urethane Resin Emulsion e: | 15 | parts |
| Acrylic Resin Emulsion f: | 5 | parts |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, manufactured | 0.1 | parts |
| by AVECIA GROUP): | | |
| Deionized water | 32.9 | parts |

### Comparative Example 4

Using the same liquid dispersion 1 of pigment as Example 1, the following recipe was mixed and stirred and thereafter filtrated by a polypropylene filter of 0.2 μm to prepare ink.

| | | |
|---|---|---|
| Liquid dispersion 1 of pigment: | 20 | parts |
| Core shell type resin emulsion: (ACRIT WEM-3045, | 15 | parts |
| Acrylic core + polycarbonate-based urethane shell, | | |
| manufactured by Taisei Fine Chemical Co., Ltd.). | | |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, | 0.1 | parts |
| manufactured by AVECIA GROUP): | | |
| Deionized water | 32.9 | parts |

### Comparative Example 5

Using the same liquid dispersion 1 of pigment as Example 1, the following recipe was mixed and stirred and thereafter filtrated by a polypropylene filter of 0.2 μm to prepare ink.

| | | |
|---|---|---|
| Liquid dispersion 1 of pigment: | 20 | parts |
| Acrylic-modified Polyether-based Resin Emulsion g: | 15 | parts |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, | 0.1 | parts |
| manufactured by AVECIA GROUP): | | |
| Deionized water | 32.9 | parts |

### Comparative Example 6

Using the same liquid dispersion 1 of pigment as Example 1. the following e was mixed and stirred and thereafter filtrated by a polypropylene filter of 0.2 μm to prepare ink.

| | | |
|---|---|---|
| Liquid dispersion 1 of pigment: | 20 | parts |
| Acrylic Resin Emulsion f: | 5 | parts |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, manufactured | 0.1 | parts |
| by AVECIA GROUP): | | |
| Deionized water | 32.9 | parts |

### Comparative Example 7

Using the same liquid dispersion 1 of pigment as Example 1, the following recipe was mixed and stirred and thereafter filtrated by a polypropylene filter of 0.2 μm to prepare ink.

| | | |
|---|---|---|
| Liquid dispersion 1 of pigment: | 20 | parts |
| Polyester resin emulsion (Elitel KT-8803, manufactured | 15 | parts |
| by UNITIKA LTD.): | | |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, | 0.1 | parts |
| manufactured by AVECIA GROUP): | | |
| Deionized water | 32.9 | parts |

### Comparative Example 8

Using the same liquid dispersion 1 of pigment as Example 1, the following recipe was mixed and stirred and thereafter filtrated by a polypropylene filter of 0.2 μm to prepare ink,

| | | |
|---|---|---|
| Liquid dispersion 1 of pigment: | 20 | parts |
| Fluorine-containing resin emulsion (LUMIFLON ® | 15 | parts |
| FE-4500, manufactured by Asahi Glass Co., Ltd.): | | |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, | 0.1 | parts |
| manufactured by AVECIA GROUP): | | |
| Deionized water | 32.9 | parts |

### Comparative Example 9

Using the same liquid dispersion 1 of pigment as Example 1, the following recipe was mixed and stirred and thereafter filtrated by a polypropylene filter of 0.2 μm to prepare ink,

| | | |
|---|---|---|
| Liquid dispersion 1 of pigment: | 20 | parts |
| Surfactant CH₃(CH₂)₁₂O(CH₂CH₂O)₃CH₂COOH: | 2 | parts |
| 1,2-propane diol: | 20 | parts |
| Diethylene glycol-n-butyl ether: | 10 | parts |
| Preservatives and fungicides (PROXEL LV, manufactured | 0.1 | parts |
| by AVECIA GROUP): | | |
| Deionized water | 47.9 | parts |

Characteristics of the inks prepared in Examples and Comparative examples were evaluated in the following manner.

The results are shown in Tables 1 and 2.

Considering outdoor use, considerably strict criteria were employed for scratch resistance in comparison with printing on plain paper. In addition, ethanol resistance was evaluated assuming that a signage, etc. was wiped by ethanol for cleaning.

Judging from the evaluation results below, the ink of the present disclosure is found to be suitable for outdoor use.

Evaluation of Image Gloss

An inkjet printer (IPSiO GXe5500, manufactured by Ricoh Co., Ltd.) was filled with each ink and a solid image was printed on a polyvinyl chloride (PVC) film (DSG-210-WH manufactured by Roland DG Corporation) followed by drying at 80° C. for one hour.

Thereafter, gloss at 60° degree of the solid image portion was measured by a gloss meter (4501, manufactured by BYK Gardener) and evaluated according to the following criteria.

Evaluation Criteria
A: Gloss at 60° 100% or more
B: Gloss at 60° from 80% to less than 100%
C: Gloss at 60° from 60% to less than 80%
D: Gloss at 60° less than 60%

Evaluation on Scratch Resistance

An inkjet printer (IPSiO GXe5500, manufactured by Ricoh Co., Ltd.) was filled with each ink and a solid image was printed on a polyvinyl chloride (PVC) film (DSG-210-WH, manufactured by Roland DG Corporation) followed by drying at 80% for one hour.

Thereafter, the solid portion was abraded by dry cotton (unbleached muslin No. 3) with a load of 400 g and evaluated about scratch resistance according to the following criteria:

Evaluation Criteria
A: No change in image when abraded 50+times
B: Slight scratch observed when abraded 50 times but causing no damage to image density with no practical problem
C: Image density degraded when abraded 21 times to 50 time
D: Image density degraded when abraded 20—times

Evaluation on Ethanol Resistance

An inkjet printer (IPSiO GXe5500, manufactured by Ricoh Co., Ltd.) was filled with each ink and a solid image was printed on a polyvinyl chloride (PVC) film (DSG-210-WH, manufactured by Roland DG Corporation) followed by drying at 80° C. for one hour.

The solid image portion was abraded 20 times by a cotton applicator impregnated in 50% aqueous solution of ethanol. The degree of peeling of the film of the solid image portion was used to evaluate ethanol resistance according to the following criteria.

Evaluation Criteria
A: No peeling-off in solid image portion, no contamination on cotton applicator
B: No peeling-off in solid image portion but slight contamination on cotton applicator
C: Ink melted portion observed on solid image portion
D: Ink on solid image portion peeled and at least one portion of PVC film exposed

Evaluation on Ink Storage

An ink cartridge was filled with each ink and stored at 65° C. for three weeks. The viscosity of the ink was measured by a viscometer (RE-80L, manufactured by TOKI SANGYO CO., LTD.) before and after the storage followed by evaluation on the state of thickening and agglomeration of the ink according to the following criteria.

Evaluation Criteria
A: Change rate of viscosity before and after storage within −5% to 5%
B: Change rate of viscosity before and after storage within −10% to less than −5% and more than 5% to 10%
C: Change rate of viscosity before and after storage within −15% to less than −10% and more than 10% to 15%

C: Change rate of viscosity before and after storage less than −15% or more than 15%

Evaluation of Discharging Stability

An inkjet printer (IPSIO GXe5500, manufactured by Ricoh Co., Ltd.) having a cover was tilled with each ink and left at 10° C. and 15% RH for one week with the cover closed. Thereafter, a nozzle checker pattern was printed and visually observed to check non-discharging and disturbance of discharging for evaluation according to the following evaluation criteria.

Evaluation Criteria
A: No non-discharging or no disturbance at all
B: Slight discharging disturbance
C: Nozzle with non-discharging confirmed
D: Multiple nozzles with non-discharging confirmed

TABLE 1

| | Example | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Image gloss evaluation | A | A | A | A | A | A | A | B | B | B | B | A |
| Scratch resistance evaluation | A | A | A | A | A | B | B | B | B | A | A | C |
| Ethanol resistance evaluation | A | A | A | A | A | B | B | A | A | A | A | C |
| Ink storage evaluation | A | A | A | A | A | A | A | A | A | B | B | A |
| Discharging stability evaluation | A | A | A | A | A | A | A | A | A | A | A | A |

TABLE 2

| | Comparative Example | | | | | | | | |
|---|---|---|---|---|---|---|---|---|---|
| | 1 | 2 | 3 | 4 | 5 | 6 | 7 | 8 | 9 |
| Image gloss evaluation | A | D | D | C | A | B | C | D | D |
| Scratch resistance evaluation | A | B | B | A | C | A | A | C | D |
| Ethanol resistance evaluation | C | C | B | C | D | C | C | D | D |
| Ink storage evaluation | B | B | A | D | A | B | D | A | A |
| Discharging stability evaluation | D | B | B | C | B | D | C | B | A |

As seen in Tables 1 and 2, Examples 1 to 5 show good results about the properties of formed layer and the stability of inkjet ink simultaneously irrespective of the difference of color difference and the kinds of solvents, etc.

Although the results of Examples 6 and 7 are inferior to those of Examples 1 and 2 about the strength of formed layer, they are practically satisfactory.

The results of Examples 8 and 9 are slightly inferior to those of Examples 3 and 4 about the strength of formed layers, thereby slightly degrading scratch resistance and gloss.

In Examples 10 and 11, the compatibility between the solvent and the resin is not perfect so that the resin particles tend to agglomerate in the drying process, thereby degrading gloss.

In addition, storage stability is also degraded.

Since the ink of Example 12 is prepared with no drying process,the performance thereof is inferior but still free from a practical problem.

In Comparative Example 1, a polycarbonate-based urethane resin having no acrylic component is used. As a result, the ethanol resistance and discharging stability of the ink were inferior.

In Comparative Examples 2 and 3, a polycarbonate-based urethane resin emulsion and an acrylic resin emulsion were used in combination. The gloss of the image is extremely inferior irrespective of the blending ratio of the two. Moreover, the performance is comprehensively inferior.

In Comparative Example 4, a resin emulsion having a two-layer structure of an acrylic core and a polycarbonate-based urethane shell is used. The storage stability of the ink is inferior, thereby degrading the gloss thereof.

In Comparison Example 5, acrylic-modified polyether-based urethane resin emulsion was used. When compared with a polycarbonate-based resin, the strength of

Comparison Example 5 is inferior, thereby degrading scratch resistance. In addition, no ethanol resistance is obtained.

In Comparative Examples 6 to 8, an acrylic resin emulsion, a polyester-based resin emulsion, and fluorine-containing resin emulsion are used. Each is comprehensively inferior to any of Examples.

The ink of Comparative Example 9 contains no resin emulsion. The content of the solid portion in the ink decreases, which contributes to improvement of the stability of the ink but the ink is not fixed on a substrate at all. That is, the ink is found to be not practically satisfying.

According to the present invention, ink for aqueous inkjet recording is provided which has high gloss, good scratch resistance, and good ethanol resistance at imaged portions when images are printed with the ink on a non-porous substrate such as plastic film, and in addition, excellent storage stability and excellent discharging stability of the ink over time.

Having now fully described embodiments of the present invention, it will be apparent to one of ordinary skill in the art that many changes and modifications can be made thereto without departing front the spirit and scope of embodiments of the invention as set forth herein.

What is claimed is:

1. Ink for aqueous inkjet recording comprising:
water:
a hydrosoluble organic solvent;
a pigment; and
an acrylic-modified polycarbonate-based urethane resin,
wherein the acrylic-modified polycarbonate-based urethane resin comprises at least one of an acrylic monomer, a methacrylic monomer, or an alkylester thereof as a component.

2. The ink for aqueous inkjet recording according to claim 1, wherein the alkyl ester comprises a methacrylic acid alkyl ester having an alkyl group having one to four carbon atoms.

3. The ink for aqueous inkjet recording according to claim 1, wherein the acrylic-modified polycarbonate-based urethane resin comprises a structure derived from at least one kind of alicyclic diisocyanate.

4. The ink for aqueous inkjet recording according to claim 1, wherein the hydrosoluble organic solvent comprises at least one of 1,2-propane diol, 1,3-propane diol, 1,2-butane diol, 1,3-butane diol, or 2,3-butane diol.

5. An inkjet recording method comprising:
printing an image with an ink for aqueous inkjet recording,
wherein the ink for aqueous inkjet recording comprises water, a hydrosoluble organic solvent, a pigment; and an acrylic-modified polycarbonate-based urethane resin,
wherein the acrylic-modified polycarbonate-based urethane resin comprises at least one of an acrylic monomer, a methacrylic monomer, or an alkylester thereof as a component.

6. The inkjet recording method according to claim 5, further comprising heating after the step of printing.

7. An inkjet printed matter comprising:
a recording medium; and
an image formed on the recording medium by the inkjet recording method of claim 5.
